(19) United States
(12) Patent Application Publication
(10) Pub. No.: US 2003/0209877 A1
(43) Pub. Date: Nov. 13, 2003

(54) Article transport apparatus

(76) Inventor: Frank Kurt Beyer, Metford (AU)

Correspondence Address: STEPTOE & JOHNSON LLP, D. Douglas Price, 1330 Connecticut Avenue, NW, Washington, DC, 20036-1795, US

(21) Appl. No.: 10/374,717

(22) Filed: Feb. 27, 2003

(30) Foreign Application Priority Data
Feb. 28, 2002 (AU) PS0804/02

(51) Int. Cl. B60P 3/071

(52) U.S. Cl. 280/414.1

(57) ABSTRACT

A loading cradle suitable for use with transport apparatus for the carriage and transport of articles, the transport apparatus including a chassis and a cradle assembly thereon for supporting the article when on the transport apparatus, the loading cradle forming part of the cradle assembly and including a support frame including side support members with an article support zone therebetween and an access region at one end thereof, said support frame when in use being mounted for at least partial rotation about a rotation axis relative to the chassis so that the access region can be selectively orientated relative to the chassis of the transport apparatus.

The present invention relates generally to the transportation of articles and more particularly to apparatus suitable for use with transport vehicles.

One particular application of the present invention concerns the transporting of articles such as power boats, yachts or similar craft and in particular trailing such water vessels over land by vehicles which may be in the form of powered vehicles or non-powered vehicles such as trailers or the like. It will be convenient to hereinafter describe the invention with reference to this particular application, however, it is to be understood that this is not to be taken as a limitation as to the scope of the invention.

Known techniques for transporting water vessels over land includes the use of trailers which, in loading and unloading operations can be moved down a ramp into the water until the trailer is partly submerged. To load a vessel, its bow makes contact with rollers mounted on the trailer, a cable is attached to the bow and the vessel is drawn up onto the trailer via a winch. Often, adverse wind, tide and current conditions and differing operator skill levels cause the vessel to approach the trailer at varying angles and multiple loading attempts must be made before the vessel may be successfully hauled aboard the trailer and transported.

The present invention seeks to provide apparatus for transporting articles which alleviates one or more of the aforementioned problems.

According to one aspect of the present invention, there is provided a loading cradle suitable for use with transport apparatus for the carriage and transport of articles, the transport apparatus including a chassis and a cradle assembly thereon for supporting the article when on the transport apparatus, the loading cradle forming part of the cradle assembly and including a support frame including side support members with an article support zone therebetween and an access region at one end thereof. The support frame when in use is mounted for at least partial rotation about a rotation axis relative to the chassis so that the access region can be selectively orientated relative to the chassis of the transport apparatus.

Preferably, the rotation axis is transverse to and, more preferably, generally normal to the plane of the chassis.

In one form the support frame may be operatively connected to a turntable for rotation thereon, the turntable being operatively connected to or forming part of the chassis of the transport apparatus.

The support frame may include a base section which is pivotally mounted to the turntable for pivotal movement about an axis transverse to and preferably at right-angles to the rotation axis of the turntable.

Preferably, the side support members are in a form of arms which are operatively connected to the base section of the support frame. Preferably, the side support members are pivotally mounted to enable adjustment of their position relative to the axis support zone.

According to another aspect of the present invention there is provided a cradle unit suitable for use with transport apparatus, the cradle unit including a support frame including side support members pivotally mounted to the support frame with an article support zone therebetween and an access region at one end thereof. One or more load bearing elements are provided in the support zone and are operatively connected to the pivotally mounted side support members each load bearing element being movable in response to the weight of the article as it enters the article support zone. The load bearing elements may be in the form of one or more preferably V-shaped rollers. The arrangement is such that the load bearing elements when depressed by a keel for example force the outer pivoting support inwards to contact the hull and as the generally V-shaped hull at the back gives way to a flatter aft hull section the mechanism maintains distributed support throughout.

In one form of the invention the cradle unit forms the loading cradle. Preferably, the loading cradle may be disposed at one end of the chassis. The loading cradle may form part of or be releasably securable to the transport apparatus. Thus the loading cradle may be used as a replacement part on existing transport apparatus. The cradle assembly may further include a further cradle section which may be disposed at the other end of the chassis. This further cradle section may include a plurality of transverse arms which may be mounted pivotally to the chassis.

According to another aspect of the invention there is provided transport apparatus which may be in the form described above and include a cradle assembly which may be in the form described above either in its broad form or more preferred form.

Preferred embodiments of the invention will hereinafter be described with reference to the accompanying drawings and in those drawings:

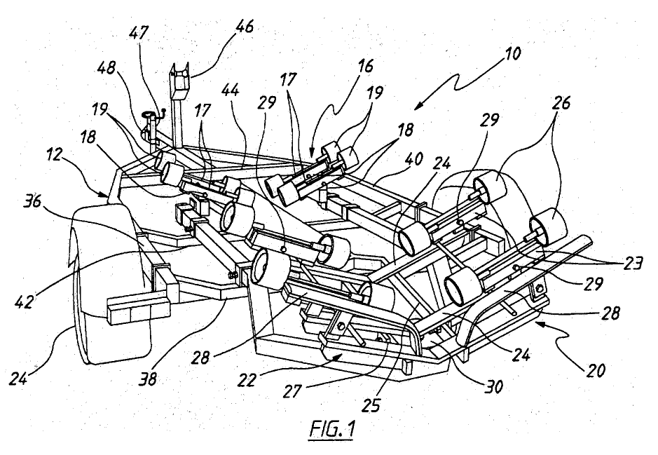

FIG. 1 is a schematic perspective view of a trailer having a loading cradle in accordance with one embodiment of the present invention;

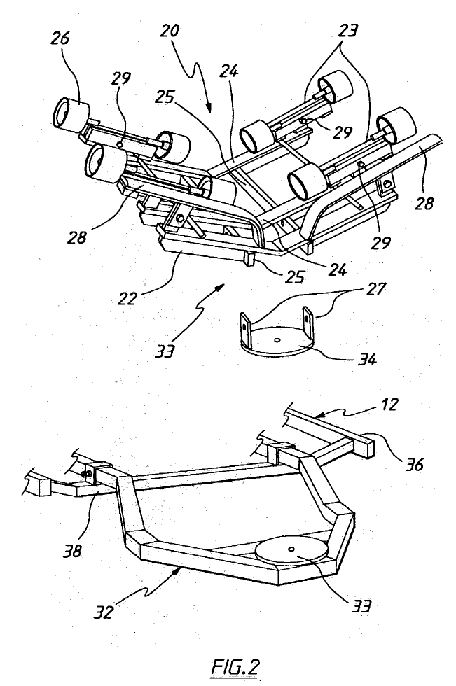

FIG. 2 is an exploded view of the loading cradle shown in FIG. 1;

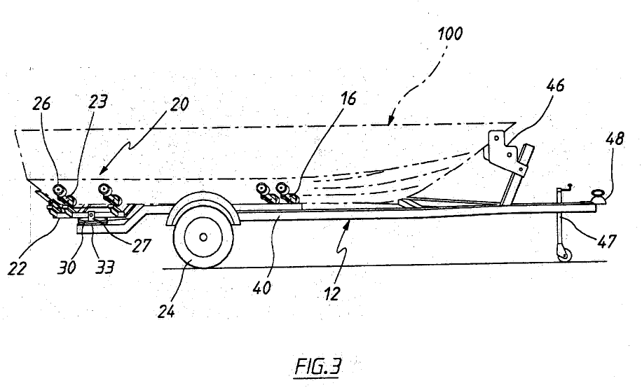

FIG. 3 is a schematic side elevation of the trailer and loading cradle shown in FIGS. 1 and 2; and

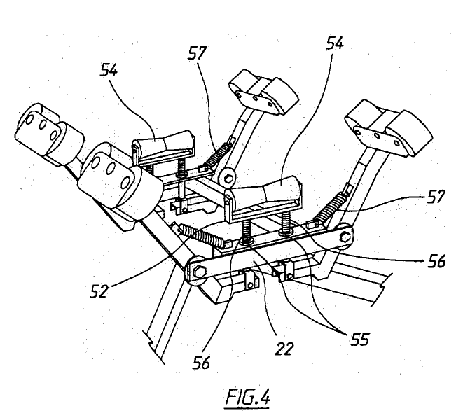

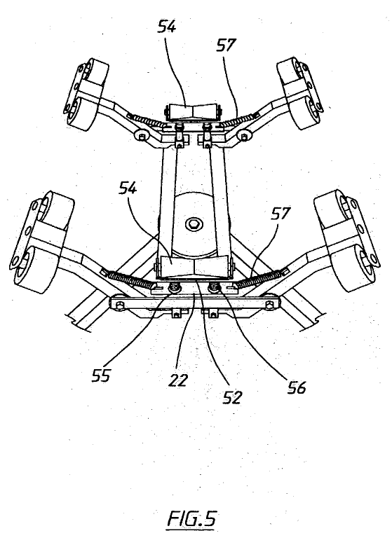

FIGS. 4 and 5 are schematic views of a loading cradle according to another embodiment of the present invention.

Referring to FIG. 1 of the drawings there is shown a transport vehicle in the form of a trailer generally indicated at 10 which is suitable for transporting water craft 100 and is adapted to be towed by a powered vehicle. The trailer 10 includes a chassis or frame 12 comprising longitudinal side beams 36 and 40 and transverse beams 38, 42 and 44. The chassis is supported on a pair of ground engaging wheels 24 for road transport. A vehicle coupling device in the form of a ball socket 48 is fitted at a front end of the trailer chassis and a cable drum and winch (not shown) is also provided at the front end, the cable being arranged to extend over cable guide 46 for connection to a water craft as is conventional. The trailer may also be supported at this end by a jockey wheel assembly when not coupled to a vehicle.

The watercraft 100 is adapted to be supported on the chassis by a cradle assembly which includes a loading cradle 20 and a forward cradle 16. The forward cradle 16 has two groups of side support arms 17 having rollers 19 associated therewith. The side support arms 17 are mounted for pivotal movement about pivot mountings 18. The forward cradle may be mounted to the chassis 12 or to a structure mounted to the chassis.

As best seen in FIGS. 2 and 3 the loading cradle 20 includes a support frame 22 which includes V-shaped mounting members 24 interconnected by cross members 25 so as to form a rigid structure. At one side of the frame a pair of guides or skids 28 are secured to the frame. An access region is provided between the guides or skids which assists in proper positioning of the water craft for subsequent loading on to the cradle assembly.

The loading cradle further includes side support arms 23 which are operatively mounted to respective sections of the mounting members. Each of the support arms 23 has sets of rollers 26 mounted thereon. The support arms 23 are mounted for pivotal movement on the mounting members about pivot mountings 29.

The loading cradle further includes a turntable 30 which is carried on a mounting frame 32 attached to or forming part of the chassis. Thus, it will be appreciated that existing trailers can be modified by attaching the mounting frame to the trailer chassis. The turntable includes a base disc 33 and a support disc 34 having mounting legs 27 thereon by which the support frame is connected to the turntable. Two low-friction plates are fitted between the base disc and support disc. A single bolt can hold the turntable assembly together. The support frame is mounted so that it can pivot relative to the turntable about an axis extending between mounting legs 27. Thus, the support frame 22 is free to rotate on the turntable relative to mounting frame 32 about an axis generally at right angles to the planes of the turntable discs.

The loading cradle enables the watercraft to enter the cradle at any angle. Once the watercraft is located at the access region it can, if desired, be manoeuvred under its own power into a position where it can be driven onto the trailer.

In the embodiment of FIGS. 4 and 5 the support frame 22 includes a control mechanism 52 which includes two V-shaped rollers 54 each mounted on slidable guides 55 which enables the rollers 54 to move up and down relative to support frame 22. The guides 55 are operatively connected to the ends of the side support arms 23. Springs 56 urge the rollers 54 into an uppermost position. Springs 57 help urge the arms inwards.

The control mechanism 52 is arranged such that the pivoting arms 23 are brought inwards when the V-rollers 54 are depressed, to maintain contact with the outer hull sections of the vessel. The corollary is that as the pivoting arms 23 are depressed, the V-rollers 54 are raised, to maintain contact with the keel.

Electric circuits for braking and turning indicator lights are also included in this embodiment, at 62, as well as safety reflectors 64 in case of open circuit or breakdown.

To load and subsequently transport a vessel, the trailer 10 is reversed down a suitable ramp or beach, until partly submerged. The vessel then approaches the rear of the trailer and the bow of the vessel enters the access region of the cradle and in the case of the embodiment of FIGS. 4 and 5 makes contact with the rear V-roller 54. Because the support cradle 20 can rotate in two axes, the cradle may be positioned to reflect the attitude and relative angle of the vessel, then the rear support cradle 20 is in position to facilitate aligning the longitudinal axes of the vessel and trailer. This aligning is expedited by the control mechanism which secures the vessel in three places for each mechanism (ie a total of six), namely the keel and either side of the hull. The positive engagement of the vessel in this way ensures the fast loading and aligning of the vessel with the trailer. A cable (not shown) is connected to the bow of the vessel, and the winch 46 hauls and, with the assistance of the rotating rear cradle, simultaneously aligns the longitudinal axis of the vessel to that of the trailer. The hauling continues until the vessel makes contact with the rollers on the further cradle section 50. By now the vessel is aligned with the longitudinal axis of the trailer and the hull moves forward until the bow meets the winch 46. The vessel may be secured with tying means (not shown) and transported.

Finally, it is to be understood that various alterations, modifications and/or additions may be incorporated into the various constructions and arrangements of parts without departing from the spirit or ambit of the invention.

The claims defining the invention are as follows:

1. A loading cradle suitable for use with transport apparatus for the carriage and transport of articles, the transport apparatus including a chassis and a cradle assembly thereon for supporting the article when on the transport apparatus, the loading cradle forming part of the cradle assembly and including a support frame including side support members with an article support zone therebetween and an access region at one end thereof, said support frame when in use being mounted for at least partial rotation about a rotation axis relative to the chassis so that the access region can be selectively orientated relative to the chassis of the transport apparatus.

2. A loading cradle according to claim 1 wherein the rotation axis is transverse to the plane of the chassis.

3. A loading cradle according to claim 2 wherein the rotation axis is generally at right angles to the plane of the chassis.

4. A loading cradle according to any preceding claim wherein the support frame is operatively connected to a turntable for rotation thereon, the turntable being operatively connected to or forming part of the chassis of the transport apparatus.

5. A loading cradle according to claim 4 wherein the support frame includes a base section which is pivotally mounted to the turntable for pivotal movement about an axis transverse to and preferably at right-angles to the rotation axis of the turntable.

6. A loading cradle according to claim 5 wherein the side support members are in a form of arms which are operatively connected to the base section of the support frame.

7. A loading cradle according to claim 6 wherein the side support members are pivotally mounted to enable adjustment of their position relative to the axis support zone.

8. A cradle unit suitable for use with transport apparatus, the cradle unit including a support frame including side support members pivotally mounted to the support frame with an article support zone therebetween and an access region at one end thereof, one or more load bearing elements in the support zone which are operatively connected to the pivotally mounted side support members each load bearing element being movable in response to the weight of the article as it enters the article support zone, the load bearing elements being in the form of one or more preferably V-shaped rollers, the arrangement being such that the load bearing elements when depressed by a keel for example force the outer pivoting support inwards to contact the hull and as the generally V-shaped hull at the back gives way to a flatter aft hull section the mechanism maintains distributed support throughout.

9. A cradle unit according to claim 8 wherein the cradle unit forms a loading cradle.

10. A cradle unit according to claim 9 wherein the loading cradle is disposed at one end of the chassis.

11. A cradle unit according to claim 10 wherein the loading cradle forms part of or is releasably securable to the transport apparatus.

12. A cradle unit according to claim 11 wherein the cradle assembly further includes a further cradle section which may be disposed at the other end of the chassis.

13. A cradle unit according to claim 12 wherein the cradle section includes a plurality of transverse arms which are mounted pivotally to the chassis.

14. Transport apparatus including a cradle assembly according to any preceding claim.
